(19) United States
(12) Patent Application Publication
(10) Pub. No.: US 2011/0042270 A1
(43) Pub. Date: Feb. 24, 2011

(54) CATALYST COMPRISING AT LEAST ONE PARTICULAR ZEOLITE AND AT LEAST ONE SILICA-ALUMINA, AND PROCESS FOR HYDROCRACKING HYDROCARBON FEEDS USING SAID CATALYST

(75) Inventors: Emmanuelle Guillon, Vernaison (FR); Christophe Bouchy, Lyon (FR); Johan Martens, Huldenberg (BE)

Correspondence Address: MILLEN, WHITE, ZELANO & BRANIGAN, P.C., 2200 CLARENDON BLVD., SUITE 1400, ARLINGTON, VA, 22201, US

(73) Assignee: IFP, Rueil-Malmaison Cedex (FR)

(21) Appl. No.: 12/811,636

(22) PCT Filed: Dec. 10, 2008
(86) PCT No.: PCT/FR2008/001721

§ 371 Date: Oct. 5, 2010

(30) Foreign Application Priority Data
Jan. 4, 2008 (FR) 08 00055

(51) Int. Cl. B01J 29/06; C10G 11/05

(52) U.S. Cl. 208/118; 502/66; 502/67

(57) ABSTRACT

The invention describes a catalyst comprising at least one hydrodehydrogenating metal selected from the group formed by metals from group VIB and metals from group VIII and a support comprising at least one silica-alumina, and at least one COK-7 zeolite alone, or mixed with at least one ZBM-30 zeolite, as well as a process for hydrocracking hydrocarbon feeds employing said catalyst.

The present invention relates to a catalyst comprising at least one hydrodehydrogenating metal selected from the group formed by metals from group VIB and metals from group VIII and a support comprising at least one silica-alumina, and at least one COK-7 zeolite alone or mixed with at least one ZBM-30 zeolite.

The invention also concerns a process for hydroconverting hydrocarbon feeds employing said catalyst. More particularly, the term “hydroconversion” means hydrocracking of hydrocarbon feeds. More particularly still, the invention can produce improved yields of middle distillates.

### PRIOR ART

Hydrocracking heavy oil cuts is a very important process in refining which can produce, from surplus heavy feeds which are of low upgradability, lighter fractions such as gasoline, jet fuel and light gas oils which the refiner needs to adapt his production to the demand structure. Certain hydrocracking processes can also produce a highly purified residue which may constitute excellent bases for oils. Compared with catalytic cracking, the advantage of catalytic hydrocracking is to produce very high quality middle distillates, jet fuel and gas oils. The gasoline produced has an octane number which is much lower than that from catalytic cracking.

One of the major advantages of hydrocracking is that it is highly flexible on several levels: flexibility as regards the catalysts used, which means that there is flexibility in the feeds to be treated and in the products obtained. One parameter which can in particular be controlled is the acidity of the catalyst support.

Catalysts used in hydrocracking are all bifunctional in type, associating an acid function with a hydrogenating function. The acid function is provided by supports with large surface areas (150 to 800 m²/g in general) with a superficial acidity, such as halogenated aluminas (in particular chlorinated or fluorinated), silica-aluminas and zeolites. The hydrogenating function is provided either by one or more metals from group VIII of the periodic table of the elements or by an association of at least one metal from group VIB of the periodic table of the elements and at least one metal from group VIII.

The vast majority of conventional catalytic hydrocracking catalysts are constituted by slightly acidic supports such as amorphous silica-aluminas, for example. More particularly, such systems are used in the production of very high quality middle distillates.

Many catalysts on the hydrocracking catalyst market are based on silica-alumina associated either with a group VIII metal or, and preferably when the quantities of heteroatomic poisons in the feed to be treated exceeds 0.5% by weight, with an association of sulphides of metals from groups VIB and VIII. Such systems have very high selectivity for middle distillates and the products formed are of very high quality. The least acidic of such catalysts can also produce lubricant bases. The disadvantage of all of those catalytic systems based on an amorphous support is, as stated above, their low activity.

Catalysts comprising a Y zeolite with structure type FAU or beta type catalysts have a higher catalytic activity than that of silica-aluminas, but have higher selectivities for unwanted light products. In prior art patents such as U.S. Pat. No. 7,199,00, U.S. Pat. No. 6,387,246 or U.S. Pat. No. 7, 169,291, the zeolites used to prepare the hydrocracking catalysts are characterized by several parameters such as their framework molar Si/Al ratio, their lattice parameters, their pore distribution, their specific surface area, their sodium ion take-up capacity or their water vapour adsorption capacity.

A number of studies have consisted of studying catalysts containing a combination of Y zeolite or beta zeolite and a silica-alumina (U.S. Pat. No. 3,816,297, U.S. Pat. No. 5,358,917, U.S. Pat. No. 6,399, 530 and U.S. Pat. No. 6,902,664) or Y zeolite with other particular zeolites (U.S. Pat. No. 4,925,546, FR-2 852 864).

EP-A-0 544 766 claims a hydrocracking process for the production of middle distillates employing a hydrocracking catalyst with wide pores and a catalyst comprising an aluminophosphate type molecular sieve with intermediate pores to improve the cold properties of the middle distillates. The hydroconversion catalyst has a hydrodehydrogenating activity and a cracking support selected from the group formed by silica-aluminas, silica-alumina-titanium, clays, zeolitic molecular sieves such as faujasites, or X, Y zeolites used alone or as a mixture, the support preferably being non-zeolitic. The aluminophosphate type molecular sieve with intermediate pores is selected from SAPO-11, SAPO-31 and SAPO-41 silicoaluminophosphates.

The studies carried out by the Applicant on many zeolites and microporous solids have led to the discovery that, surprisingly, a catalyst comprising at least one hydrodehydrogenating metal selected from the group formed by metals from group VIB and metals from group VIII and a support comprising at least one silica-alumina and at least one COK-7 zeolite alone or as a mixture with at least one ZBM-30 zeolite results in unexpected catalytic performances in hydrocracking hydrocarbon feeds, and more particularly can produce middle distillate yields (kerosene and gas oil) which are substantially improved compared with known prior art catalysts and/or can result in improved quality products.

Thus, the invention concerns such a catalyst as well as a process for hydrocracking hydrocarbon feeds employing said catalyst.

### DETAILED DESCRIPTION OF THE INVENTION

More precisely, the invention provides a catalyst comprising at least one hydrodehydrogenating metal selected from the group formed by metals from group VIB and metals from group VIII and a support comprising at least one silica-alumina, and at least one COK-7 zeolite alone or mixed with at least one ZBM-30 zeolite.

The invention also concerns a hydrocracking process employing said catalyst.

### Support

### Zeolites

According to the invention, the catalyst support of the present invention comprises at least one COK-7 zeolite alone or mixed with at least one ZBM-30 zeolite.

The ZBM-30 zeolite is described in patent EP-A-0 046 504, and COK-7 zeolite is described in patent applications EP-1 702 888 A1 or FR-2 882 744 A1.

Preferably, the COK-7 zeolite used in the catalyst of the present invention is synthesized in the presence of a triethylenetetramine organic template.

Preferably, the ZBM-30 zeolite used in the catalyst of the present invention is synthesized in the presence of a triethylenetetramine organic template.

More preferably, the catalyst support of the present invention comprises at least one COK-7 zeolite synthesized in the presence of a triethylenetetramine organic template mixed with at least one ZBM-30 zeolite synthesized in the presence of a triethylenetetramine organic template.

In the case in which the catalyst support of the present invention comprises at least one COK-7 zeolite mixed with at least one ZBM-30 zeolite, the proportion of each of the zeolites in the mixture of two zeolites is advantageously in the range 20% to 80% by weight with respect to the total weight of the mixture of the two zeolites, and preferably the proportion of each of the zeolites in the mixture of the two zeolites is in the range 30% to 70% by weight with respect to the total weight of the mixture of the two zeolites.

In a preferred implementation, the catalyst support of the present invention may also comprise at least one zeolite selected from the group formed by zeolites with structure type TON, FER, MTT.

Zeolites with structure type TON are described in the work entitled “Atlas of Zeolite Structure Types”, W M Meier, D H Olson and C h Baerlocher, 5^{th} Revised Edition, 2001, Elsevier.

The zeolite with structure type TON which may also form part of the composition of the catalyst support of the present invention is advantageously selected from the group formed by Theta-1, ISI-1, NU-10, KZ-2 and ZSM-22 zeolites described in the work “Atlas of Zeolite Structure Types” cited above as well as, as regards ZSM-22 zeolite, in patents U.S. Pat. No. 4,564,77 U.S. Pat. No. 4,902,406 and as regards NU-10 zeolite, in patents EP-A-0 065 400 and EP-A-0 077 624.

The zeolite with structure type FER which may also form part of the composition of the catalyst support of the present invention is advantageously selected from the group formed by ZSM-35, ferrierite, FU-9 and ISI-6 zeolites described in the “Atlas of Zeolite Structure Types” cited above.

The zeolite with structure type MTT which may also form part of the composition of the catalyst support of the present invention is advantageously selected from the group formed by ZSM-23, EU-13, ISI-4 and KZ-1 zeolites described in the “Atlas of Zeolite Structure Types” cited above, as well as in U.S. Pat. No. 4,076,842 as regards ZSM-23 zeolite.

Preferred zeolites with structure type TON which may also form part of the composition of the catalyst support of the present invention are ZSM-22 and NU-10 zeolites.

Preferred zeolites with structure type PER which may also form part of the composition of the catalyst support of the present invention are ZSM-35 and ferrierite zeolites.

A preferred zeolite with structure type MTT which may also form part of the composition of the catalyst support of the present invention is ZSM-23 zeolite.

In a preferred embodiment, the catalyst support of the invention contains a mixture of COK-7 zeolite with at least one zeolite selected from the group formed by zeolites with structure type TON, FER, MTT, the COK-7 zeolite optionally being mixed with ZBM-30 zeolite. Preferably, the catalyst support of the invention contains a mixture of two zeolites and more preferably, a mixture of COK-7 zeolite with ZSM-22 zeolite or NU-10 zeolite.

The proportion of each of the zeolites in the mixture of two zeolites is advantageously in the range 20% to 80% by weight with respect to the total weight of the mixture of the two zeolites, and preferably the proportion of each of the zeolites in the mixture of two zeolites is 50% by weight with respect to the total weight of the mixture of the two zeolites.

The zeolites present in the catalyst support of the invention advantageously comprise silicon and at least one element T selected from the group formed by aluminium, iron, gallium, phosphorus and boron; preferably, said element T is aluminium.

The overall Si/Al ratio of the zeolites forming part of the composition of the catalyst support of the invention as well as the chemical composition of the samples are determined by X-ray fluorescence and atomic absorption.

The Si/Al ratios of the zeolites described above are advantageously those obtained on synthesis using the operating procedures described in the various cited documents or obtained after dealuminating post-synthesis treatments which are well known to the skilled person, non-exhaustive illustrations of which are hydrothermal treatments which may or may not be followed by acid attacks or direct acid attacks using solutions of mineral or organic acids.

The zeolites forming part of the composition of the catalyst support of the invention are advantageously calcined and exchanged with at least one treatment using a solution of at least one ammonium salt to obtain the ammonium form of the zeolites which, once calcined, produce the hydrogen form of said zeolites.

The zeolites forming part of the composition of the catalyst support of the invention are advantageously at least in part, preferably almost completely, in the acid form, i.e. in the (H⁺) acid form. The Na/T atomic ratio is generally and advantageously less than 0.1 and preferably less than 0.5, and more preferably less than 0.01.

### Silica-Alumina

In accordance with the invention, the catalyst support of the invention also comprises at least one silica-alumina.

Silica-aluminas cannot be considered to be aluminosilicates which approach ideality as do zeolites. It is possible to obtain silica-aluminas over the complete composition range from 0 to 100% Al₂O₃, but the degree of association of the two elements Si and Al and thus the homogeneity of the solid are strongly dependent on the method of preparation.

Any silica-alumina which is known in the art is appropriate for use in the invention.

In accordance with a preferred embodiment, the silica-alumina is homogeneous on the micrometric scale and contains a quantity of more than 5% by weight and 95% or less by weight of silica (SiO₂), said silica-alumina having the following characteristics:
a mean pore diameter, measured by mercury porosimetry, in the range 20 to 140 Å;
a total pore volume, measured by mercury porosimetry, in the range 0.1 ml/g to 0.5 ml/g;
a total pore volume, measured by nitrogen porosimetry, in the range 0.1 ml/g to 0.5 ml/g;
a BET specific surface area in the range 100 to 550 m²/g;
a pore volume, measured by mercury porosimetry, included in pores with a diameter of more than 140 Å, of less than 0.1 ml/g;
a pore volume, measured by mercury porosimetry, included in pores with a diameter of more than 160 Å, of less than 0.1 ml/g;
a pore volume, measured by mercury porosimetry, included in pores with a diameter of more than 200 Å, of less than 0.1 ml/g;
a pore volume, measured by mercury porosimetry, included in pores with a diameter of more than 500 Å, of less than 0.1 ml/g;
an X-ray diffraction diagram which contains at least the principal characteristic peaks of at least one of the transition aluminas included in the group composed by alpha, rho, khi, eta, gamma, kappa, theta and delta aluminas.

Preferably, said silica-alumina contains:
a mass of silica (SiO₂) in the range 10% to 80% by weight, preferably a mass of silica of more than 20% by weight and less than 80% by weight and still more preferably more than 25% by weight and less than 75% by weight, the silica content advantageously being in the range 10% to 50% by weight, said silica content being measured using X-ray fluorescence;
a cationic impurities content (for example Na⁺) of less than 0.1% by weight, preferably less than 0.05% by weight and still more preferably less than 0.025% by weight. The term “cationic impurities content” means the total amount of alkalis and alkaline-earths;
an anionic impurities content (for example SO₄²⁻, Cl⁻) of less than 1% by weight, preferably less than 0.5% by weight and still more preferably less than 0.1% by weight.

### Hydrogenating Phase

In accordance with the invention, the catalyst also comprises a hydrogenating function, i.e. at least one hydrodehydrogenating element selected from the group formed by metals from group VIII and group VIB, used alone or as a mixture.

Preferably, the group VIII elements are selected from iron, cobalt, nickel, ruthenium, rhodium, palladium, osmium, iridium and platinum, used alone or as a mixture.

In the case in which the group VIII elements are selected from noble metals from group VIII, the group VIII elements are advantageously selected from platinum and palladium.

In the case in which the group VIII elements are selected from non-noble metals from group VIII, the group VIII elements are advantageously selected from iron, cobalt and nickel.

Preferably, the group VIB elements of the catalyst of the present invention are selected from tungsten and molybdenum.

In the case in which the hydrogenating function comprises a group VIII element and a group VIB element, the following combinations of metals are preferred: nickel-molybdenum, cobalt-molybdenum, iron-molybdenum, iron-tungsten, nickel-tungsten and cobalt-tungsten, and highly preferably: nickel-molybdenum, cobalt-molybdenum and nickel-tungsten. It is also possible to use combinations of three metals such as nickel-cobalt-molybdenum. When these combinations of metals are used, these metals are preferably used in their sulphide form.

The quantity of hydrodehydrogenating element in said catalyst of the present invention selected from metals from group VIB and group VIII is in the range 0.1% to 60% by weight with respect to the total mass of said catalyst, preferably in the range 0.1% to 50% by weight and highly preferably in the range 0.1% to 40% by weight.

When the hydrodehydrogenating element is a noble metal from group VIII, the catalyst preferably has a noble metal content of less than 5% by weight, more preferably less than 2% by weight with respect to the total mass of said catalyst. The noble metals are preferably used in their reduced form.

Optionally, the catalyst of the present invention also comprises at least one oxide type amorphous or low crystallinity porous mineral matrix selected from aluminas, aluminates and silicas. Preferably, a matrix is used which contains alumina, in any form known to the skilled person, and highly preferably gamma alumina.

Optionally, the catalyst also comprises at least one doping element selected from the group formed by boron, silicon and phosphorus, preferably boron and/or silicon.

The doping element selected from the group formed by boron, silicon and/or phosphorus may advantageously be in the matrix, the zeolite, the silica-alumina or preferably, it may be deposited on the catalyst and in this case be principally located on the matrix.

The doping element introduced, in particular silicon, principally located on the matrix of the support may advantageously be characterized using techniques such as Castaing microprobe (distribution profile of the various elements), transmission electron microscopy coupled with X-ray analysis of the catalyst components, or by mapping the distribution of the elements present in the catalyst by electron microprobe.

Optionally, the catalyst also comprises at least one element from group VIIA, preferably chlorine and fluorine, and also optionally at least one element from group VIIB.

### Composition of Catalyst

The catalyst of the present invention advantageously and generally comprises, as a by weight with respect to the total catalyst mass:
0.1% to 60%, preferably 0.1% to 50% and more preferably 0.1% to 40% of at least one hydrodehydrogenating element selected from the group formed by metals from group VIB and group VIII;
0 to 99% and preferably 0 to 98%, preferably 0 to 95% of at least one oxide type amorphous or low crystallinity porous mineral binder apart from silica-alumina;
said catalyst also comprises 0.1% to 99%, preferably 0.2% to 99.8%, highly preferably 0.5% to 90% and still more preferably 1% to 80% of at least one COK-7 zeolite used alone or in the case in which the COK-7 zeolite is used as a mixture with at least one ZBM-30 zeolite, the proportion of each of the zeolites in the mixture of two COK-7 and ZBM-30 zeolites is advantageously in the range 20% to 80% by weight with respect to the total weight of the mixture of the two zeolites, and preferably the proportion of each of the zeolites in the mixture of two zeolites is in the range 30% to 70% by weight with respect to the total weight of the mixture of the two zeolites;
1% to 99% of silica-alumina as described in the text;
   said catalyst optionally comprising:
0 to 60%, preferably 5% to 40% of at least one zeolite selected from the group formed by zeolites with structure type TON, FER, MTT;
0 to 20%, preferably 0.1% to 15%, and more preferably 0.1% to 10% of at least one promoter element selected from the group formed by silicon, boron and phosphorus, and preferably boron and/or silicon;
0 to 20%, preferably 0.1% to 15% and still more preferably 0.1% to 10% of at least one element selected from group VIIA, preferably fluorine.

The metals from group VIB and group VIII of the catalyst of the present invention are advantageously present completely or partially in the metallic form and/or the oxide form and/or the sulphide form.

### Preparation of Catalyst

The catalysts used in the process of the present invention may be prepared using any of the methods which are known to the skilled person, starting from a support based on a silico-alumina matrix and based on at least one COK-7 zeolite used alone or mixed with at least one ZBM-30 zeolite. The catalyst also contains a hydrogenating phase.

### Preparation of Silica-Alumina

Any process for synthesising silica-alumina which is known to the skilled person resulting in a homogeneous silica-alumina on a micrometric scale and in which the cationic impurities (for example Na⁺) may be reduced to less than 0.1%, preferably to an amount of less than 0.05% by weight and still more preferably to less than 0.025% by weight and in which the anionic impurities (for example SO₄²⁻, Cl⁻) may be reduced to less than 1% and more preferably to less than 0.05% by weight is suitable for the preparation of supports for use in the process for preparing the silica-alumina used in the catalyst of the invention.

Silico-alumina matrices which are advantageously obtained from mixing at any stage either a partially soluble compound of alumina in an acid medium with a completely soluble silica compound or with a completely soluble combination of alumina and hydrated silica, which is then formed, followed by a hydrothermal treatment or thermal treatment to homogenize it on a micrometric scale or on the nanometric scale, can produce a particularly active catalyst. The Applicant uses the term “partially soluble in an acidic medium” to mean that bringing the alumina compound into contact before adding any completely soluble silica compound or combination with an acid solution, for example nitric acid or sulphuric acid, causes their partial dissolution.

### Sources of Silica

The silica compounds used in the invention may advantageously have been selected from the group formed by silicic acid, silicic acid sols, hydrosoluble alkali silicates, cationic silicon salts, for example hydrated sodium metasilicate, Ludox® in the ammoniacal form or in the alkaline form; and quaternary ammonium silicates. The silica sol may advantageously be prepared using one of the methods known to the skilled person. Preferably, a decationized solution of orthosilicic acid is prepared from a hydrosoluble alkaline silicate by ion exchange over a resin.

### Completely Soluble Silica-Alumina Sources

The completely soluble hydrated silica-aluminas used in the invention may advantageously be prepared by true co-precipitation under controlled stationary operating conditions (pH, concentration, temperature, mean residence time) by reacting a basic solution containing silicon, for example in the form of sodium silicate, optionally aluminium, for example in the form of sodium aluminate, with an acidic solution containing at least one aluminium salt, for example aluminium sulphate. At least one carbonate or CO₂ may optionally be added to the reaction medium.

The Applicant uses the term “true co-precipitation” to mean a process by which at least one completely soluble aluminium compound in a basic or acidic medium as described above, and at least one compound of silicon as described above are brought into contact, simultaneously or sequentially, in the presence of at least one precipitating and/or co-precipitating compound to obtain a mixed phase essentially constituted by hydrated silica-alumina which is optionally homogenized by intense agitation, shearing, colloidal milling or by a combination of these individual operations.

### Sources of Alumina

The alumina compounds used in accordance with the invention are advantageously partially soluble in an acidic medium. They are advantageously entirely or partially selected from the group of alumina compounds with general formula Al₂O₃, nH₂O. In particular, it is possible to use hydrated alumina compounds such as: hydrargillite, gibbsite, bayerite, boehmite, pseudo-boehmite and amorphous or essentially amorphous alumina gels. It is also advantageous to use dehydrated forms of these compounds which are constituted by transition aluminas and which comprise at least one of the phases in the group: rho, khi, eta, gamma, kappa, theta and delta, which differ essentially in the organization of their crystalline structure. Alpha alumina, commonly known as corundum, may advantageously be incorporated in small proportions into the support of the invention.

More preferably, the aluminium hydrate Al₂O₃, nH₂O used is boehmite, pseudo-boehmite and amorphous or essentially amorphous alumina gels. A mixture of these products in any advantageous combination may also be used.

Boehmite is generally described as an aluminium monohydrate with formula Al₂O₃, nH₂O which in reality encompasses a wide continuum of materials with a variety of degrees of hydration and organization with boundaries which may or may not be well defined: the most hydrated gelatinous boehmite, with n which may be more than 2, pseudo-boehmite or micro-crystalline boehmite with n in the range 1 to 2, then crystalline boehmite and finally highly crystalline boehmite in large crystals with n close to 1. The morphology of aluminium monohydrate can vary widely between these two extreme forms, acicular or prismatic. There is a huge variety of different forms which may be used between these two forms: chains, boats, interlaced platelets.

Relatively pure aluminium hydrate can advantageously be used in the form of amorphous or crystalline powders or crystalline powders containing an amorphous portion. The aluminium hydrate may also advantageously be introduced in the form of aqueous suspensions or dispersions. The aqueous suspensions or dispersions of aluminium hydrate used in accordance with the invention may advantageously be capable of being gelled or capable of being coagulated. The aqueous dispersions or suspensions may also advantageously be obtained, as is well known to the skilled person, by peptization in water or water acidulated with hydrates of aluminium.

The aluminium hydrate may advantageously be dispersed using any process which is known to the skilled person: in a “batch” reactor, a continuous mixer, a mixer, or a colloidal mill. Such a mixture may advantageously also be produced in a plug flow reactor and in particular in a static mixer. “Lightnin” reactors may be cited.

Further, it is also advantageous to use, as the source of alumina, an alumina which has undergone a treatment which can improve its degree of dispersion. As an example, the dispersion of the alumina source could be improved by a preliminary homogenization treatment. Advantageously, the homogenization step can employ at least one of the homogenization treatments described in the text below.

The aqueous alumina dispersions or suspensions which may be used are advantageously aqueous suspensions or dispersions of fine or ultra-fine boehmites which are composed of particles with dimensions in the colloidal domain.

The fine or ultra fine boehmites used in accordance with the present invention may advantageously be obtained in accordance with French patent FR-B-1 261 182 and FR-B-1 381 282 or in European patent application EP-A-0 015 196.

It is also advantageously possible to use aqueous dispersions or suspensions obtained from pseudo-boehmite, amorphous alumina gels, aluminium hydroxide gels or ultra fine hydrargillite.

The aluminium monohydrate may advantageously be purchased from a variety of commercial sources of alumina such as PURAL®, CATAPAL®, DISPERAL®, or DISPAL® sold by SASOL or HIQ® sold by ALCOA, or using methods which are known to the skilled person: it may be prepared by partial dehydration of aluminium trihydrate using conventional methods or it may advantageously be prepared by precipitation. When said aluminas are in the form of a gel, they are advantageously peptized by water or an acidulated solution. For precipitation, the acid source may advantageously, for example, be selected from at least one of the following compounds: aluminium chloride, aluminium sulphate, or aluminium nitrate. The basic source of aluminium may advantageously be selected from basic salts of aluminium such as sodium aluminate or potassium aluminate.

### Preparation of Zeolite

The zeolites used in the catalyst of the invention are advantageously commercial zeolites or zeolites synthesized using the procedures described in the patents cited above. The zeolites forming part of the composition of the catalyst of the invention are advantageously at least in part, but preferably practically completely in the acid form, i.e. in the hydrogen form (H⁺).

### Preparation of Zeolite-Silica-Alumina Matrix

The matrix of the invention may advantageously be prepared using any of the methods known to the skilled person from supports prepared as described above.

The zeolite may advantageously be introduced using any method which is known to the skilled person and at any stage in the preparation of the support or catalyst.

A preferred process for preparing a catalyst in accordance with the present invention comprises the following steps:

In a preferred preparation mode, the zeolite may advantageously be introduced during the preparation of the silica-alumina. In a non-limiting manner, the zeolite may advantageously be in the form of a powder, a ground powder, a suspension, or a suspension which has undergone a de-agglomeration treatment, for example. Thus, for example, the zeolite may advantageously be taken up into a suspension which may or may not be acidulated to a concentration adjusted to the final zeolite content envisaged for the support. This suspension, routinely known as a slurry, is then advantageously mixed with precursors of the silica-alumina at any stage in its synthesis, as described above.

In another preferred preparation mode, the zeolite may advantageously also be introduced during formation of the support with the elements which constitute the matrix, possibly with at least one binder. In a non-limiting manner, the zeolite may advantageously be in the form of a powder, a ground powder, a suspension, or a suspension which has undergone a de-agglomeration treatment.

The preparation and the treatment or treatments as well as the formation of the zeolite may advantageously thereby constitute a step in the preparation of these catalysts. Advantageously, the zeolite/silica-alumina matrix is obtained by mixing the silica-alumina and the zeolite then forming the mixture.

### Forming the Supports and Catalysts

The zeolite/silica-alumina matrix may advantageously be formed using any technique which is known to the skilled person. Forming may advantageously be carried out, for example, by extrusion, pelletization, using the oil-drop coagulation method, by rotary plate granulation or using any method which is known to the skilled person.

Forming may also advantageously be carried out in the presence of the various constituents of the catalyst and extrusion of the mineral paste obtained by pelletization, forming into beads using a rotary or drum bowl granulator, oil-drop coagulation, oil-up coagulation or any other known process for agglomerating a powder containing alumina and possibly other ingredients selected from those mentioned above.

The catalysts used in accordance with the invention are advantageously in the form of spheres or extrudates. However, it is advantageous for the catalyst to be in the form of extrudates with a diameter in the range 0.5 to 5 mm and more particularly in the range 0.7 to 2.5 mm. Advantageously, they may be in the form of cylinders (which may or may not be hollow), twisted cylinders, multilobes (2, 3, 4 or 5 lobes, for example), or rings. The cylindrical form is advantageously and preferably used, but any other form may be used.

Further, said supports which are employed in the present invention may advantageously have been treated, as is well known to the skilled person, using additives to facilitate forming and/or to improve the final mechanical properties of the supports based on silico-alumina matrices. Examples of additives which may especially be cited are cellulose, carboxymethyl cellulose, carboxyethyl cellulose, tall oil, xanthan gums, surfactants, flocculating agents such as polyacrylamides, carbon black, starches, stearic acid, polyacrylic alcohol, polyvinyl alcohol, biopolymers, glucose, polyethylene glycols, etc.

Forming may advantageously be carried out using techniques for forming catalysts which are known to the skilled person, such as: extrusion, bowl granulation, spray drying or pelletization.

Advantageously, water can be added or removed to adjust the viscosity of the paste to be extruded. This step can advantageously be carried out at any stage in the mixing step.

To adjust the amount of solid material in the paste to be extruded in order to render it extrudable, it is also advantageous to add a mainly solid compound, preferably an oxide or a hydrate. Preferably, a hydrate is used, more preferably an aluminium hydrate. The loss on ignition of said hydrate is preferably over 15%.

The amount of acid added on mixing before forming is advantageously less than 30%, preferably in the range 0.5% to 20% by weight of the anhydrous mass of silica and alumina engaged in the synthesis.

Extrusion may advantageously be carried out using any conventional tool which is commercially available. The paste which results from mixing is advantageously extruded through a die, for example using a piston or a single- or twin-extrusion screw. This extrusion step may advantageously be carried out using any method which is known to the skilled person.

The extrudates of the support of the invention advantageously and generally have a crush strength of at least 70 N/cm and preferably 100 N/cm or more.

### Calcining Zeolite/Silica-Alumina Support

Drying is carried out using any technique which is known to the skilled person.

To obtain the support of the present invention, it is preferable to calcine, preferably in the presence of molecular oxygen, for example by flushing with air, at a temperature of 1100° C. or less. At least one calcining step may advantageously be carried out after any one of the preparation steps. This treatment, for example, may advantageously be carried out in a flushed bed, a trickle bed or in a static atmosphere. As an example, the furnace used may be a rotary furnace or it may be a vertical furnace with radial flushed layers. The calcining conditions (temperature, duration) principally depend on the maximum service temperature of the catalyst. The preferred calcining conditions are advantageously between more than one hour at 200° C. and less than one hour at 1100° C. Calcining may advantageously be carried out in the presence of steam. Final calcining may optionally be carried out in the presence of an acidic or basic vapour. As an example, calcining may be carried out in a partial pressure of ammonia.

### Post-Synthesis Treatments

Post-synthesis treatments may advantageously be carried out to improve the properties of the catalyst.

In accordance with the invention, the zeolite/silica-alumina support may thus optionally undergo a hydrothermal treatment in a confined atmosphere. The term “hydrothermal treatment in a confined atmosphere” means a treatment by passage through an autoclave in the presence of water at a temperature higher than ambient temperature.

During said hydrothermal treatment, it may be advantageous to treat the support. Thus, the support may advantageously be impregnated, prior to its passage through the autoclave, autoclaving being carried out either in the vapour phase or in the liquid phase, said vapour or liquid phase of the autoclave being acidic or otherwise. Prior to autoclaving, said impregnation may advantageously be dry or by immersing the support in an aqueous acidic solution. The term “dry impregnation” means bringing the support into contact with a volume of solution which is smaller than or equal to the total pore volume of the support. Preferably, dry impregnation is carried out.

The autoclave is preferably a rotary basket autoclave such as that defined in patent application EP-A-0 387 109.

The temperature during autoclaving may advantageously be in the range 100° C. to 250° C. for a period in the range 30 minutes to 3 hours.

### Deposition of Hydrogenating Phase

The hydrodehydrogenating element may advantageously be introduced at any step of the preparation, highly preferably after forming the zeolite/silica-alumina support. Forming is advantageously followed by calcining; the hydrogenating element may also advantageously be introduced before or after said calcining. Preparation is generally completed by calcining at a temperature of 250° C. to 600° C. Another preferred method of the present invention advantageously consists of forming the support after mixing the latter, then passing the paste obtained through a die to form extrudates with a diameter in the range 0.4 to 4 mm. All or part of the hydrogenating function may advantageously then be introduced at the time of mixing. It may also advantageously be introduced using one or more ion exchange operations carried out on the calcined support constituted by at least one silica-alumina, at least one COK-7 zeolite alone or mixed with at least one ZBM-30 zeolite and optionally formed with a binder using solutions containing precursor salts of the selected metals.

Preferably, the support is impregnated with an aqueous solution. The support is preferably impregnated using the “dry” impregnation method which is well known to the skilled person. Impregnation may advantageously be carried out in a single step using a solution containing all of the constituent elements of the final catalyst.

The hydrogenating function may also advantageously be introduced using one or more ion exchange operations carried out on the calcined support constituted by a zeolite as described above, dispersed in the selected matrix using solutions containing the precursor salts of the selected metals.

The hydrogenating function may advantageously be introduced using one or more operations for impregnation of the formed and calcined support, using a solution containing at least one precursor of at least one oxide of at least one metal selected from the group formed by metals from groups VIII and metals from group VIB, the precursor(s) of at least one oxide of at least one metal from group VIII preferably being introduced after those of group VIB or at the same time therewith if the catalyst contains at least one metal from group VIB and at least one metal from group VIII.

In the case in which the catalyst advantageously contains at least one element from group VIB, for example molybdenum, it is, for example, possible to impregnate the catalyst using a solution containing at least one element from group VIB, to dry and to calcine. Molybdenum impregnation may advantageously be facilitated by adding phosphoric acid to the ammonium paramolybdate solutions, which means that the phosphorus can also be introduced in a manner that promotes the catalytic activity.

In a preferred implementation of the invention, the catalyst contains, as a dopant, at least one element selected from silicon, boron and phosphorus. Said elements are advantageously introduced onto a support already containing at least one COK-7 zeolite alone or mixed with at least one ZBM-30 zeolite, at least one silica-alumina, as defined above, and at least one metal selected from the group formed by metals from group VIB and metals from group VIII.

In the case in which the catalyst contains boron, silicon and phosphorus and optionally the element selected from group VIIA, halide ions, said elements may advantageously be introduced into the catalyst at various stages of the preparation and in a variety of manners.

The metal is preferably impregnated using the “dry” impregnation method which is well known to the skilled person. Impregnation may advantageously be carried out in a single step using a solution containing all of the constituent elements of the final catalyst.

The P, B, Si and the element selected from the halide ions of group VIIA may advantageously be introduced using one or more impregnation operations carried out using an excess of solution on the calcined precursor.

In the case in which the catalyst contains boron, a preferred method of the invention consists of preparing an aqueous solution of at least one boron salt such as ammonium biborate or ammonium pentaborate in an alkaline medium and in the presence of hydrogen peroxide and to proceed to dry impregnation, wherein the volume of the pores of the precursor is filled with the boron-containing solution.

In the case in which the catalyst contains silicon, a solution of a silicone type silicon compound is advantageously employed.

In the case in which the catalyst contains boron and silicon, the boron and silicon may advantageously also be deposited simultaneously using a solution containing a boron salt and a silicone type silicon compound. Thus, for example in the case in which, for example, the precursor is a nickel-molybdenum type catalyst supported on a support containing zeolite and alumina, it is possible to impregnate said precursor using an aqueous solution of ammonium biborate and Rhodorsil E1P silicone from Rhone-Poulenc, to dry at 80° C., for example, then to impregnate with a solution of ammonium fluoride, to dry, for example at 80° C., and then to calcine, for example and preferably in air in a flushed bed, for example at 500° C. for 4 hours.

In the case in which the catalyst contains at least one element from group VIIA, preferably fluorine, it is, for example, advantageously possible to impregnate the catalyst with a solution of ammonium fluoride, to dry, for example at 80° C., and to calcine, for example and preferably in air in a flushed bed, for example at 500° C. for 4 hours.

Other impregnation sequences may advantageously be carried out to obtain the catalyst of the present invention.

In the case in which the catalyst contains phosphorus, it is, for example, possible and advantageous to impregnate the catalyst with a solution containing phosphorus, to dry, and to calcine.

In the case in which the elements contained in the catalyst, i.e. at least one metal selected from the group formed by metals from group VIII and group VIB, optionally boron, silicon, or phosphorus, and at least one element from group VIIA, are introduced in several steps for impregnation with the corresponding precursor salts, an intermediate step for drying the catalyst is generally and advantageously carried out at a temperature which is generally in the range 60° C. to 250° C. and an intermediate step for calcining the catalyst is generally and advantageously carried out at a temperature in the range 250° C. to 600° C.

To finish the preparation of the catalyst, advantageously the moist solid is left in a moist atmosphere at a temperature in the range 10° C. to 80° C., then the moist solid obtained is dried at a temperature in the range 60° C. to 150° C., and finally the solid obtained is calcined at a temperature in the range 150° C. to 800° C.

Sources of elements from group VIB which may advantageously be used are well known to the skilled person. Advantageous examples of sources of molybdenum and tungsten which may be used are oxides and hydroxides, molybdic and tungstic acids and salts thereof, in particular ammonium salts such as ammonium molybdate, ammonium heptamolybdate, ammonium tungstate, phosphomolybdic acid, phosphotungstic acid and their salts, silicomolybdic acid, or silicotungstic acid and their salts. Preferably, ammonium oxides and salts such as ammonium molybdate, ammonium heptamolybdate and ammonium tungstate are used.

The sources of the group VIII elements which may advantageously be used are well known to the skilled person. As an example, for non-noble metals, it is advantageous to use nitrates, sulphates, phosphates, halides, for example chlorides, bromides or fluorides, carboxylates, for example acetates, hydroxides or carbonates. For noble metals, halides are advantageously used, for example chlorides, nitrates, acids such as chloroplatinic acid, or oxychlorides such as ammoniacal ruthenium oxychloride. It is also advantageous to use cationic complexes such as ammonium salts when platinum is to be deposited on the zeolite by cationic exchange.

The preferred phosphorus source is orthophosphoric acid H₃PO₄, but its salts and esters such as ammonium phosphates are also suitable. Phosphorus may, for example, be introduced in the form of a mixture of phosphoric acid and a basic organic compound containing nitrogen such as ammonia, primary and secondary amines, cyclic amines, compounds from the pyridine family and quinoleins and compounds from the pyrrole family.

A number of silicon sources may advantageously be employed. Thus, it is possible to use ethyl orthosilicate Si(OEt)₄, siloxanes, polysiloxanes, silicates of halides such as ammonium fluorosilicate (NH₄)₂SiF₆ or sodium fluorosilicate Na₂SiF₆. Silicomolybdic acid and its salts, silicotungstic acid and its salts may also advantageously be employed. The silicon may be added, for example by impregnation with ethyl silicate in solution in a water/alcohol mixture. The silicon may, for example, be added by impregnation with a silicone type silicon compound in suspension in water.

The boron source may advantageously be boric acid, preferably orthoboric acid H₃BO₃, ammonium biborate or pentaborate, boron oxide, or boric esters. The boron may, for example, be introduced in the form of a mixture of boric acid, hydrogen peroxide and a basic organic compound containing nitrogen such as ammonia, primary and secondary amines, cyclic amines, compounds from the pyridine family and quinoleins and compounds from the pyrrole family. The boron may advantageously be introduced, for example, by means of a solution of boric acid in a water/alcohol mixture.

Sources of the group VIIA elements which may advantageously be used are well known to the skilled person. As an example, fluoride anions may advantageously be introduced in the form of hydrofluoric acid or its salts. These salts are formed with alkali metals, ammonium or an organic compound. In this latter case, the salt is advantageously formed in the reaction mixture by reaction between the organic compound and hydrofluoric acid. It is also possible to use hydrolysable compounds which can release fluoride anions in water, such as ammonium fluorosilicate (NH₄)₂SiF₆, silicon tetrafluoride SiF₄ or sodium hexafluoride Na₂SiF₆. The fluorine may advantageously be introduced, for example by impregnation with an aqueous hydrofluoric acid or ammonium fluoride solution.

The catalysts obtained in the form of oxides after calcining may optionally be at least partially transformed into their metallic or sulphide form.

The catalysts obtained in the present invention are advantageously formed into grains with different forms and dimensions. They are advantageously generally used in the form of cylindrical or polylobed extrudates such as bilobes, trilobes, polylobes with a straight or twisted form, but may also be manufactured and employed in the form of crushed powders, tablets, rings, beads, or wheels. They have a specific surface area measured by nitrogen adsorption using the BET method (Brunauer, Emmett, Teller, J Am Chem Soc vol 60, 309-316 (1938)) in the range 50 to 600 m²/g, a pore volume measured by mercury porosimetry in the range 0.2 to 1.5 cm³/g and a pore size distribution which may be monomodal, bimodal or polymodal.

In accordance with the present invention, the catalysts obtained are employed in reactions for the conversion of hydrocarbon feeds (in the broad sense of transformation) and in particular for hydrocracking reactions.

### Feeds

In accordance with the invention, the catalysts described above are employed in reactions for hydrocracking hydrocarbon feeds such as oil cuts.

The feeds which are advantageously employed in the process are gasolines, kerosenes, gas oils, vacuum gas oils, atmospheric residues, vacuum residues, atmospheric distillates, vacuum distillates, heavy fuels, oils, waxes and paraffins, spent oils, deasphalted residues or crudes, feeds deriving from thermal or catalytic conversion processes and mixtures thereof. They contain heteroatoms such as sulphur, oxygen and nitrogen and possibly metals. Feeds from the Fischer-Tropsch process are excluded.

The catalysts of the invention are used in the hydrocracking process of the invention and preferably in a process for hydrocracking hydrocarbon heavy vacuum distillate type cuts, deasphalted or hydrotreated residues or the like. The heavy cuts are preferably constituted by at least 80% by volume of compounds with boiling points of at least 350° C. and preferably in the range 350° C. to 580° C. (i.e. corresponding to compounds containing at least 15 to 20 carbon atoms). They generally contain heteroatoms such as sulphur and nitrogen. The nitrogen content is usually in the range 1 to 5000 ppm by weight and their sulphur content is in the range 0.01% to 5% by weight.

The catalysts used in the process for hydrocracking hydrocarbon feeds in accordance with the invention preferably undergo a sulphurization treatment to at least partially transform the metallic species into sulphide before bringing them into contact with the feed to be treated. This treatment for activation by sulphurization is well known to the skilled person and may be accomplished using any treatment which has been described in the literature.

A conventional sulphurization method which is well known to the skilled person consists of heating the catalyst in the presence of hydrogen sulphide to a temperature in the range 150° C. to 800° C., preferably in the range 250° C. to 600° C., generally in a flushed bed reaction zone.

The catalyst of the present invention may advantageously be employed in hydrocracking vacuum distillate type cuts which contain large quantities of sulphur and nitrogen. The desired products are middle distillates and/or oils. Advantageously, hydrocracking is used in combination with a prior hydrotreatment step in a process for the improved production of middle distillates jointly with the production of base oils having a viscosity index in the range 95 to 150.

### Hydrocracking Processes

The invention also concerns hydrocracking processes employing the hydrocracking catalysts of the invention.

The hydrocracking conditions such as temperature, pressure, hydrogen recycle ratio, or hourly space velocity may vary widely as a function of the nature of the feed, the quality of the desired products and the facilities available to the refiner. The temperature is generally and advantageously more than 200° C. and preferably in the range 250° C. to 480° C. The pressure is advantageously more than 0.1 MPa and preferably more than 1 MPa. The hydrogen recycle ratio is advantageously a minimum of 50 and preferably in the range 80 to 5000 normal litres of hydrogen per litre of feed. The hourly space velocity is advantageously in the range 0.1 to 20 volumes of feed per volume of catalyst per hour.

The hydrocracking processes of the invention advantageously cover pressure and conversion ranges encompassing mild hydrocracking to high pressure hydrocracking.

The term “mild hydrocracking” means hydrocracking which advantageously results in moderate conversions, generally less than 55%, and preferably less than 40%, and which functions at low pressure, generally in the range 2 MPa to 12 MPa and preferably in the range 2 MPa to 6 MPa.

The term “high pressure hydrocracking” means hydrocracking advantageously resulting in high conversions, generally more than 55%, and operating at high pressure, generally more than 6 MPa.

The catalyst of the present invention may advantageously be used alone or in one or more catalytic beds, in one or more reactors in a hydrocracking layout termed once-through hydrocracking, with or without a liquid recycle of the unconverted fraction, optionally in association with a hydrorefining catalyst located upstream of the catalyst of the present invention.

In a two-step hydrocracking layout with intermediate separation between the two reaction zones, the catalyst of the present invention is advantageously used in the second reaction zone in one or more beds in one or more reactors, in association or otherwise with a hydrorefining catalyst located upstream of the catalyst of the present invention.

### Once-Through Process

Once-through hydrocracking advantageously comprises, in the first place and in general, intense hydrorefining which is intended to carry out hydrodenitrogenation and intense desulphurization of the feed before it is sent to the hydrocracking catalyst proper, in particular in the case where the latter comprises a zeolite. Said intense hydrorefining of the feed involves only a limited conversion of the feed into lighter fractions which is still insufficient and thus must be completed on the more active hydrocracking catalyst. However, it should be noted that no separation is involved between the two types of catalyst. All of the effluent from the reactor is advantageously injected onto the hydrocracking catalyst proper and only then can the products formed be separated. This version of hydrocracking, termed once-through, has a variation which advantageously involves recycling the unconverted fraction to the reactor with a view to more intense conversion of the feed.

In a first partial hydrocracking implementation, also termed mild or moderate hydrocracking, the degree of conversion is advantageously less than 55% and preferably less than 40%. The catalyst of the invention is then advantageously used at a temperature which is generally 230° C. or more and preferably 300° C. or more, generally at most 480° C., and usually in the range 350° C. to 450° C. The pressure is advantageously more than 2 MPa and preferably 3 MPa, and less than 12 MPa and preferably less than 10 MPa. The quantity of hydrogen is advantageously a minimum of 100 normal litres of hydrogen per litre of feed and preferably in the range 200 to 3000 normal litres of hydrogen per litre of feed. The hourly space velocity is advantageously in the range 0.15 to 10 h⁻¹. Under these conditions, the catalysts of the present invention have better activity as regards conversion, hydrodesulphurization and hydrodenitrogenation than commercial catalysts.

In a second implementation, hydrocracking is carried out at high pressure (total pressure more than 6 MPa), the degree of conversion then advantageously being more than, 55%. The process of the invention then operates at a temperature which is advantageously 230° C. or more and preferably in the range 300° C. to 480° C. and more preferably in the range 300° C. to 440° C., at a pressure of more than 5 MPa and preferably more than 7 MPa, highly preferably more than 10 MPa and more preferably more than 12 MPa, at a minimum quantity of hydrogen of 100 Nl/l of feed and preferably in the range 200 to 3000 Nl/l of hydrogen per litre of feed and at an hourly space velocity which is generally in the range 0.15 to 10 h⁻¹.

### Two-Step Process Implementation

Two-step hydrocracking advantageously comprises a first step which, as in the once-through process, is intended to carry out hydrorefining of the feed but also to achieve a conversion of the latter which is generally of the order of 40% to 60%. The effluent from the first step then advantageously undergoes separation (distillation) which is usually termed intermediate separation which is aimed at separating the conversion products from the unconverted fraction. In the second step of a two-step hydrocracking process, only the fraction of the feed which is not converted in the first step is treated. This separation means that a two-step hydrocracking process can be more selective for middle distillate (kerosene+diesel) than a once-through process. In fact, intermediate separation of conversion products prevents them from being “overcracked” to naphtha and gas in the second step on the hydrocracking catalyst. Further, it should be noted that the unconverted fraction of the feed treated in the second step generally contains very small quantities of sulphur and NH₃ as well as organic nitrogen-containing compounds, in general less than 20 ppm by weight or even less than 10 ppm by weight.

The catalysts used in the second step of two-step hydrocracking processes are preferably catalysts based on noble elements from group VIII, more preferably catalysts based on platinum and/or palladium.

In the case in which the process for conversion of the oil cut is carried out in two-steps, the catalysts of the invention are advantageously used in the second step.

In a first implementation, the process of the present invention may advantageously be used for partial hydrocracking, i.e. mild or moderate, advantageously under moderate pressure conditions, of cuts, for example of the vacuum distillate type with high sulphur and nitrogen contents which have already been hydrotreated. In this hydrocracking mode, the degree of conversion is less than 55% and preferably less than 40%. The catalyst of the first step may advantageously be any hydrotreatment catalyst which is known to the skilled person. This hydrotreatment catalyst advantageously comprises a matrix, preferably based on alumina and at least one metal having a hydrogenating function. The hydrotreatment function is provided by at least one metal or compound of a metal, used alone or in combination, selected from metals from group VIII and group VIB, for example selected from nickel, cobalt, molybdenum and tungsten in particular. Further, said catalyst may optionally contain phosphorus and optionally boron.

The first step is advantageously carried out at a temperature of 350-460° C., preferably 360-450° C., at a total pressure of at least 2 MPa, and preferably 3 MPa, at an hourly space velocity of 0.1 to 5 h⁻¹ and preferably 0.2 to 2 h⁻¹ and with a quantity of hydrogen of at least 100 Nl/Nl of feed, preferably 260-3000 Nl/Nl of feed.

For the conversion step with the catalyst of the invention (or second step), the temperatures are advantageously 230° C. or more and usually in the range 300° C. to 480° C., preferably in the range 330° C. to 450° C. The pressure is advantageously at least 2 MPa and preferably 3 MPa, and is less than 12 MPa and preferably less than 10 MPa. The quantity of hydrogen is advantageously a minimum of 100 Nl/l of feed and preferably in the range 200 to 3000 Nl/l of hydrogen per litre of feed. The hourly space velocity is advantageously in general in the range 0.15 to 10 h⁻¹. Under these conditions, the catalysts of the present invention have better activity as regards conversion, hydrodesulphurization, hydrodenitrogenation and better selectivity for middle distillates than commercial catalysts. The service life of the catalysts is also improved within the moderate pressure range.

In another two-step implementation, the catalyst of the present invention may be employed for hydrocracking under high pressure conditions of at least 6 MPa. The treated cuts are, for example, of the vacuum distillate type which contain large quantities of sulphur and nitrogen which have already been hydrotreated. In this hydrocracking mode, the degree of conversion is more than 55%. In this case, the process for conversion of an oil cut is advantageously carried out in two-steps, the catalyst of the invention being used in the second step.

The catalyst of the first step may advantageously be any hydrotreatment catalyst which is known to the skilled person. This hydrotreatment catalyst advantageously comprises a matrix, preferably based on alumina and at least one metal having a hydrogenating function. The hydrotreatment function is provided by at least one metal or compound of a metal, used alone or in combination, selected from metals from group VIII and group VIB, such as nickel, cobalt, molybdenum or tungsten in particular. Further, this catalyst may optionally contain phosphorus and optionally contain boron.

The first step is advantageously carried out at a temperature of 350-460° C., preferably 360-450° C. and a pressure of more than 3 MPa, an hourly space velocity of 0.1 to 5 h⁻¹ and preferably 0.2 to 2 h⁻¹ and with a quantity of hydrogen of at least 100 Nl/Nl of feed, preferably 260-3000 Nl/Nl of feed.

For the conversion step with the catalyst of the invention (or second step), the temperatures are advantageously 230° C. or more and usually in the range 300° C. to 480° C., preferably in the range 300° C. to 440° C. The pressure is advantageously more than 5 MPa and preferably more than 7 MPa, more preferably more than 10 MPa and still more preferably more than 12 MPa. The quantity of hydrogen is advantageously a minimum of 100 Nl/l of feed and preferably in the range 200 to 3000 Nl/l of hydrogen per litre of feed. The hourly space velocity is advantageously generally in the range 0.15 to 10 h⁻¹.

Under these conditions, the catalysts of the present invention have better activity as regards conversion and better selectivity for middle distillates than commercial catalysts even with considerably lower quantities of zeolite than in commercial catalysts.

In a process for the production of oils advantageously using the hydrocracking process of the invention, it is operated as disclosed in patent U.S. Pat. No. 5,525,209 with a first hydrotreatment step carried out under conditions which can produce an effluent with a viscosity index of 90-130 and a reduced quantity of nitrogen and polyaromatic compounds. In a subsequent hydrocracking step, the effluent is advantageously treated in accordance with the invention so as to adjust the value of the viscosity index to that desired by the operator.

The following examples illustrate the invention without, however, limiting its scope.

### Example 1

Preparation of:
a hydrocracking catalyst C1 (in accordance with the invention) containing a COK-7 zeolite and a silica-alumina;
a hydrocracking catalyst C2 (in accordance with the invention) containing a COK-7 zeolite, a ZBM-30 zeolite and a silica-alumina;
a catalyst C3 (not in accordance with the invention) containing silica-alumina alone;
and a catalyst C4 (not in accordance with the invention) containing a Y zeolite and a silica-alumina.

The COK-7 zeolite was synthesized as described in BP-1 702 888 A1 with the triethylenetetramine organic template. Next, it underwent calcining at 550° C. in a stream of dry air for 12 hours. The H-COK-7 zeolite (acid form) obtained had a Si/Al ratio of 52 and a Na/Al ratio of less than 0.002.

The ZBM-30 zeolite was synthesized as described in BASF's patent EP-A-0 046 504 with the triethylenetetramine organic template. Next, it underwent calcining at 550° C. in a stream of dry air for 12 hours. The H-ZBM-30 (acid form) zeolite obtained had a Si/Al ratio of 45 and a Na/Al ratio of less than 0.001.

The silica-alumina precursor SA1 was prepared as follows: an alumina hydrate was prepared as described in patent U.S. Pat. No. 3,124,418. After filtration, the freshly prepared precipitate (P1) was mixed with a solution of silicic acid prepared by exchange, over a decationizing resin. The proportions of the two solutions were adjusted so as to produce a composition of 70% of Al₂O₃-30% of SiO₂ on the final solid. This mixture was rapidly homogenized in a commercial colloidal mill in the presence of nitric acid so that the amount of nitric acid in the suspension at the outlet from the mill was 8% with respect to the mixed silica-alumina solid. Next, the suspension (P2) was dried conventionally in a spray dryer from 300° C. to 60° C. The prepared powder was formed in a Z arm mixer in the presence of 8% of nitric acid with respect to the anhydrous product. Extrusion was carried out by passing the paste through a die provided with orifices with a diameter of 1.4 mm. The extrudates E1 obtained containing 100% silica-alumina were dried at 150° C. then calcined at 550° C. then calcined at 750° C. in the presence of steam.

Next, 5 g of COK-7 zeolite as described above and 15 g of the silica-alumina precursor P2 described above were mixed. Mixing was carried out before introducing it into the extruder. The powdered zeolite was moistened and added to the suspension of the matrix in the presence of 66% nitric acid (7% by weight of acid per gram of dry gel) then mixed for 15 minutes. After mixing, the paste obtained was passed through a die with cylindrical orifices with a diameter of 1.4 mm. The extrudates were then dried overnight at 120° C. in air and, calcined at 550° C. in air. Extrudates E2 contained 20% by weight of COK-7 zeolite and 80% by weight of silica-alumina.

Next, 3 g of COK-7 zeolite, 2 g of the ZBM-30 zeolite described above and 15 g of the silica-alumina precursor P2 described above were mixed. Mixing was carried out before introducing it into the extruder. The zeolite powder was moistened and added to the suspension of the matrix in the presence of 66% nitric acid (7% by weight of acid per gram of dry gel) then mixed for 15 minutes. After mixing, the paste obtained was passed through a die with cylindrical orifices with a diameter of 1.4 mm. The extrudates were then dried overnight at 120° C. in air and calcined at 550° C. in air. Extrudates E3 contained 20% by weight of zeolite (60% COK-7+40% ZBM-30) and 80% of silica-alumina.

Extrudates E1, E2 and E3 were then dry impregnated with an aqueous solution of ammonium heptamolybdate, nickel nitrate and orthphosphoric acid, dried overnight at 120° C. in air and finally calcined in air at 550° C. The amounts by weight as the oxides in catalysts C1, C2 and C3 obtained were 3.0% of NiO, 14.0% of MoO₃ and 4.6% of P₂O₅.

Catalyst C4 was identical to catalyst C1, with Y zeolite in place of the COK-7 zeolite. The Y zeolite used was a commercial zeolite with reference CBV780 (Zeolyst International). It had a Si/Al ratio of 43.5 and a Na/Al ratio of less than 0.004.

### Example 2

### Evaluation of Catalysts in the Hydrocracking of a Vacuum Distillate

Catalysts C1, C2, C3 and C4 were evaluated for the hydrocracking of a vacuum distillate under high conversion hydrocracking conditions (60-100%). The oil feed was a hydrotreated vacuum distillate with the following principal characteristics:

| | |
|---|---|
| density (20/4) | 0.8610 |
| sulphur (ppm by weight) | 12 |
| nitrogen (ppm by weight) | 4 |
| simulated distillation: | |
| initial point | 180° C. |
| 10% point | 275° C. |
| 50% point | 443° C. |
| 90% point | 537° C. |
| end point | 611° C. |

This feed was obtained by hydrotreatment of a vacuum distillate over a HR448 Catalyst sold by AXENS comprising an element from group VIB and an element from group VIII deposited on alumina.

To the hydrotreated feed was added a sulphur-containing compound which was a precursor for H₂S (DMDS) and a nitrogen-containing compound which was a precursor for NH₃ (aniline) in order to simulate the partial pressures of H₂S and NH₃ present in the second hydrocracking step. The feed was then supplemented with 2.5% of sulphur and 1400 ppm of nitrogen. The prepared feed was injected into the hydrocracking test unit which comprised a fixed bed reactor, in upflow feed mode into which 50 ml of catalyst C1, C2 or C3 had been introduced. Before injecting the feed, the catalyst was sulphurized using a gas oil+DMDS+aniline mixture up to 320° C. It should be noted that any in situ or ex situ sulphurization method is suitable. Once sulphurization had been carried out, the feed described above could be transformed. The operating conditions of the test unit were as follows:

| | |
|---|---|
| total pressure | 14.9 MPa |
| catalyst | 50 ml |
| temperature | adjusted to obtain the desired conversion |
| hydrogen flow rate | 50 Nl/h |
| feed flow rate | 50 cm³/h |

The catalytic performances were expressed as the temperature which could produce a gross degree of conversion of 80% and the gross selectivity for 150-380° C. middle distillates. These catalytic performances were measured on the catalyst after stabilization period, generally at least 48 hours, had passed.

The gross conversion, GC, was equal to:

GC=% by weight of 380° C.⁻ in effluent.

The gross selectivity, GS, for middle distillate was equal to:

$$G S = 100 \times \frac{weight of ( 150 - 380 ° C . ) fraction in effluent}{Weight of 380 ° C . fraction in effluent}$$

The middle distillates obtained were composed of products with a boiling point in the range 150° C. to 380° C.

Table 1 below shows the reaction temperature and the gross selectivity for catalysts C1 and C2.

Table 1 demonstrates that adding COK-7 to the silica-alumina can improve both the activity of the catalyst and the selectivity for middle distillates.

TABLE 1
Catalytic activities of catalyst in hydrocracking, high gross conversion
(80%)

| | | | Gross selectivity for |
|---|---|---|---|
| | | | (150-380° C.) middle |
| Reference | Composition | T (° C.) | distillates (wt %) |
| C3 | NiMoP/SiO₂—Al₂O₃ | 396 | 67.1 |
| C1 | NiMoP/COK-7 + | 388 | 68.1 |
| | SiO₂—Al₂O₃ | | |
| C2 | NiMoP/COK-7 + | 388 | 68.6 |
| | ZBM-30 SiO₂—Al₂O₃ | | |

Table 2 demonstrates that adding COK-7 to silica-alumina compared with Y zeolite can improve the selectivity for middle distillates at iso-conversion.

TABLE 2
Catalytic activities of catalyst in hydrocracking, high gross conversion
(80%)

| | | | Gross selectivity for |
|---|---|---|---|
| | | | (150-380° C.) middle |
| Reference | Composition | T (° C.) | distillates (wt %) |
| C1 | NiMoP/COK-7 + | 388 | 68.6 |
| | SiO₂—Al₂O₃ | | |
| C4 | NiMoP/Y + SiO₂—Al₂O₃ | 380 | 66.2 |

1. A catalyst comprising at least one hydrodehydrogenating metal selected from metals from group VIB and metals from group VIII and a support comprising at least one silica-alumina and at least one COK-7 zeolite alone or mixed with at least one ZBM-30 zeolite.

2. A catalyst according to claim 1, in which said COK-7 zeolite was synthesized in the presence of a triethylenetetramine organic template.

3. A catalyst according to claim 1, in which said ZBM-30 zeolite was synthesized in the presence of a triethylenetetramine organic template.

4. A catalyst according to claim 1, in which said support also comprises at least one zeolite selected from zeolites with structure type TON, FER, or MTT.

5. A catalyst according to claim 1, in which said silica-alumina contains a quantity of more than 5% by weight and 95% by weight or less of silica (SiO₂), said silica-alumina having the following characteristics:
a mean pore diameter, measured by mercury porosimetry, in the range 20 to 140 Å;
a total pore volume, measured by mercury porosimetry, in the range 0.1 ml/g to 0.5 ml/g;
a total pore volume, measured by nitrogen porosimetry, in the range 0.1 ml/g to 0.5 ml/g;
a BET specific surface area in the range 100 to 550 m²/g;
a pore volume, measured by mercury porosimetry, included in pores with a diameter of more than 140 Å, of less than 0.1 ml/g;
a pore volume, measured by mercury porosimetry, included in pores with a diameter of more than 160 Å, of less than 0.1 ml/g;
a pore volume, measured by mercury porosimetry, included in pores with a diameter of more than 200 Å, of less than 0.1 ml/g;
a pore volume, measured by mercury porosimetry, included in pores with a diameter of more than 500 Å, of less than 0.1 ml/g;
an X-ray diffraction diagram which contains at least the principal characteristic peaks of at least one of the transition aluminas included in the group composed by alpha, rho, khi, eta, gamma, kappa, theta and delta aluminas.

6. A catalyst according to claim 5, comprising group VIII metals selected from platinum and palladium.

7. A catalyst according to claim 6, comprising group VIII metals selected from iron, cobalt and nickel.

8. A catalyst according to claim 1, comprising group VIB metals selected from tungsten and molybdenum.

9. A catalyst according to claim 1, in which the quantity of the hydrodehydrogenating metal is in the range 0.1% to 60% by weight with respect to the total mass of said catalyst.

10. In a catalytic hydrocracking process the improvement wherein the catalyst is according to claim 1.

11. A hydrocracking process according to claim 10, in which the process is a once-through process.

12. A hydrocracking process according to claim 10, in which the process is a two-step process.

13. A hydrocracking process according to claim 10, in which it is carried out under moderate hydrocracking conditions at temperatures of 230° C. or more, at a pressure of at least 2 MPa and less than 12 MPa, with a quantity of hydrogen which is a minimum of 100 Nl/l of feed and at an hourly space velocity in the range 0.15 to 10 h⁻¹.

14. A hydrocracking process according to claim 10, which is carried out under high pressure hydrocracking conditions, at a temperature of 230° C. or more, at a pressure of more than 5 MPa, with a quantity of hydrogen which is a minimum of 100 Nl/l of feed at an hourly space velocity which is generally in the range 0.15 to 10 h⁻¹.

15. A hydrocracking process according to claim 10, in which the feeds are gasolines, kerosenes, gas oils, vacuum gas oils, atmospheric residues, vacuum residues, atmospheric distillates, vacuum distillates, heavy fuels, oils, waxes and paraffins, spent oils, deasphalted residues or crudes, feeds deriving from thermal or catalytic conversion processes, and mixtures thereof.

16. A catalyst according to claim 1 comprising nickel and molybendum.

17. A catalyst according to claim 5 further comprising at least one zeolite with structure type TON, FER, or MTT
